(19) United States
(12) Patent Application Publication
(10) Pub. No.: US 2024/0397862 A1
(43) Pub. Date: Dec. 5, 2024

(54) OSCILLATING CHAFF PAN FOR WEED SEED MILL OF COMBINE HARVESTER

(71) Applicant: CNH Industrial America LLC, New Holland, PA (US)

(72) Inventor: Nathan E. Isaac, II, Lancaster, PA (US)

(21) Appl. No.: 18/694,591

(22) PCT Filed: Sep. 22, 2022
(86) PCT No.: PCT/US2022/044415

§ 371 Date: Mar. 22, 2024

Related U.S. Application Data
(60) Provisional application No. 63/246,951, filed on Sep. 22, 2021.

(51) Int. Cl. A01D 41/12; A01F 12/40

(52) U.S. Cl. CPC A01D 41/1243; A01F 12/40

(57) ABSTRACT

An agricultural harvester includes an oscillating cleaning shoe to which one or more sieves are connected, and a seed mill having an inlet for receiving a stream of chaff material, and an outlet through the stream of chaff material is expelled. A pan is configured to be connected to the oscillating cleaning shoe. The pan has a surface that is configured to direct the stream of chaff material into the inlet of the seed mill.

### FIELD OF THE INVENTION

The present invention relates to agricultural harvesters. More specifically, the present invention relates to an oscillating chaff pan for a weed seed mill of a combine harvester.

### BACKGROUND OF THE INVENTION

As is described in U.S. Pat. No. 10,314,232 to CNH America LLC (the '232 Patent), which is incorporated by reference in its entirety and for all purposes, an agricultural harvester known as a “combine” is historically termed such because it combines multiple harvesting functions with a single harvesting unit, such as picking, threshing, separating and cleaning. The separating system of the combine directs the non-grain material to a residue system. The residue system distributes the non-grain material through a chopper, a spreader, and/or a windrow chute before it is distributed onto the field.

Crop residue that is discharged onto fields often contains lost grain and seeds, including shrunken crop seeds and weed seeds. Most or all of the seeds are in the chaff that exits the cleaning system. Many of the seeds are not destroyed and remain viable after exiting the combine. Viable seeds can germinate and sprout in the field, resulting in the spread of undesired weeds and potential crop disease. Weeds that sprout are typically killed by tillage or chemical treatment, however, weed control measures such as these are costly. Moreover, these weed control measures require additional equipment passing over the field, which can increase soil compaction and adversely impact the condition of the field.

The '232 Patent discloses a weed seed mill positioned for destroying the weed seeds through shearing forces. A weed seed mill may also be referred to herein or in the art as a seed processor, chaff mill, chaff mill assembly, or chaff processor. The seed mill is configured to receive crop residue from a cleaning system of the combine and destroy or damage seeds through shearing forces, so that when the seeds exit the combine, the seeds are no longer viable and able to germinate.

It would be desirable to incorporate an oscillating chaff pan into the combine harvester for directing the chaff, including weed seeds, into an inlet of a weed seed mill.

### SUMMARY OF THE INVENTION

According to one aspect of the invention, an agricultural harvester includes an oscillating cleaning shoe to which one or more sieves are connected, and a seed mill having an inlet for receiving a stream of chaff material, and an outlet through the stream of chaff material is expelled. A pan is configured to be connected to the oscillating cleaning shoe. The pan has a surface that is configured to direct the stream of chaff material into the inlet of the seed mill.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side view of an embodiment of an agricultural harvester in the form of a combine illustrating the residue handling system of the present invention in a cutout view toward the rear of the harvester;

FIG. 2 is a rear perspective view of some of the components of the harvester of FIG. 1 showing further details of the present invention;

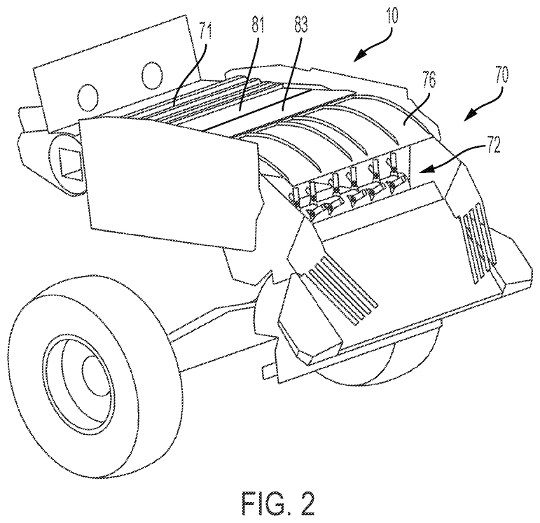

FIG. 3 is a side cutaway view of the residue handling system of FIGS. 1 and 2, whereby the residue handling system is shown schematically and various features are shown cut-away;

FIG. 4 is a cross-sectional view of the residue handling system of FIG. 3 taken along the lines 4-4;

FIG. 5 is a side elevation view of the residue handling system of FIGS. 2-4 showing an arrangement of drive belts;

FIG. 6A is a rear facing isometric view of a subassembly including the chaff pan, seal, seed mill and cleaning shoe, wherein the seal is shown in a raised configuration; and

FIG. 6B is another rear facing isometric view of the subassembly of FIG. 6A, wherein the seal is shown in a lowered configuration.

It is noted that the figures depict the elements in schematic form and are not necessarily to scale.

### DETAILED DESCRIPTION OF THE INVENTION

Corresponding reference characters indicate corresponding parts throughout the several views. The exemplification set out herein illustrates an embodiment of the invention, in one form, and such exemplification is not to be construed as limiting the scope of the invention in any manner.

Inasmuch as various components and features of harvesters are of well-known design, construction, and operation to those skilled in the art, the details of such components and their operations will not generally be discussed in significant detail unless considered of pertinence to the present invention or desirable for purposes of better understanding.

In the drawings, like numerals refer to like items, certain elements and features may be labeled or marked on a representative basis without each like element or feature necessarily being individually shown, labeled, or marked, and certain elements are labeled and marked in only some, but not all, of the drawing figures.

The terms “grain”, “chaff”, “straw”, and “tailings” are used principally throughout this specification for convenience but it is to be understood that these terms are not intended to be limiting. Thus “grain” refers to that part of the crop material that is threshed and separated from the discardable part of the crop material, which is referred to as chaff and includes straw, seeds, and other non-grain crop material.

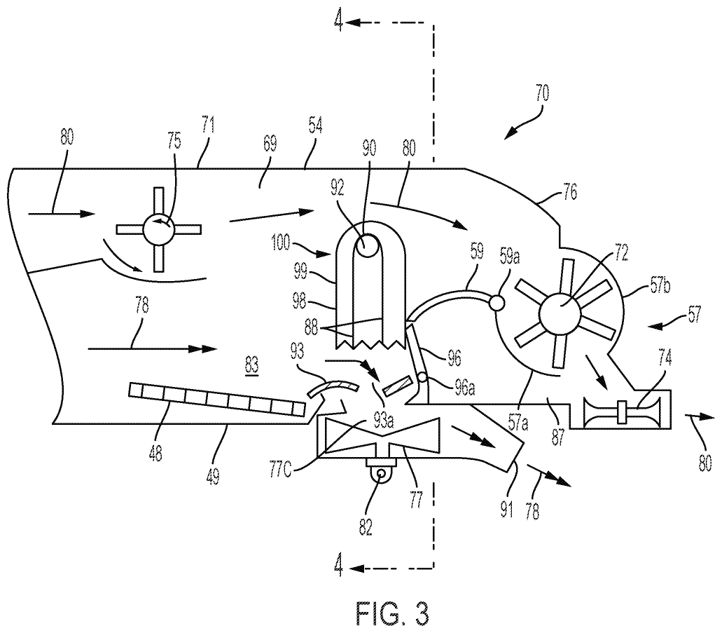

Also the terms “forward”, “rearward”, “left” and “right”, when used in connection with the agricultural harvester and/or components thereof are usually determined with reference to the direction of forward operative travel of the harvester, but again, they should not be construed as limiting. The terms “longitudinal” and “transverse” are determined with reference to the fore-and-aft direction of the agricultural harvester and are equally not to be construed as limiting. The terms “upstream” and “downstream” are determined with reference to the crop flow stream arrows shown in FIG. 3.

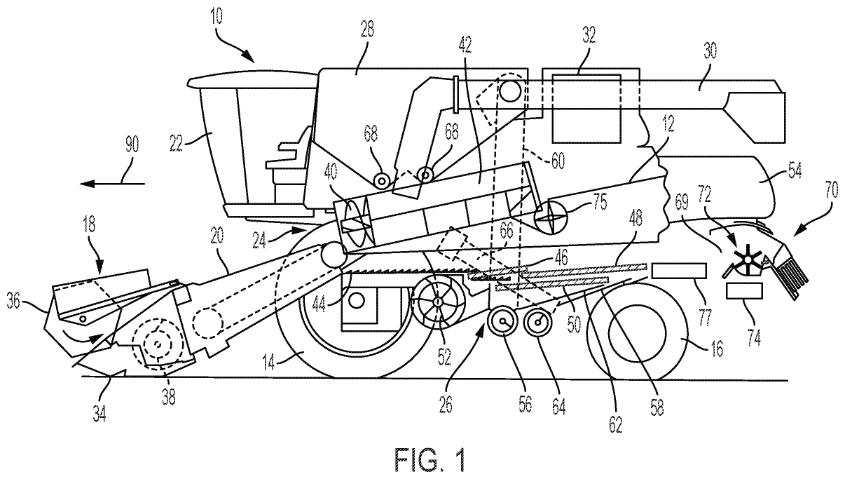

Referring now to the drawings, and more particularly to FIG. 1, there is shown an agricultural harvester in the form of a combine 10, which generally includes a chassis 12, ground engaging wheels 14 and 16, a header 18, a feeder housing 20, an operator cab 22, a threshing and separating system 24, a cleaning system 26, a grain tank 28, and an unloading conveyance 30. Motive force is selectively applied to the front wheels 14 through a power plant in the form of a diesel engine 32 and a transmission (not shown). Both the front and rear wheels 14 and 16 may be steerable.

The header 18 is mounted to the front of the combine 10 and includes a cutter bar 34 for severing crops from a field during forward motion of combine 10. A rotatable reel 36 feeds the crop into the header 18, and a double auger 38 feeds the severed crop laterally inwardly from each side toward the feeder housing 20. The feeder housing 20 conveys the cut crop to threshing and the separating system 24.

The threshing and separating system 24 is of the axial-flow type, and generally includes a rotor 40 at least partially enclosed by and rotatable within a corresponding perforated concave 42. The cut crops are threshed and separated by the rotation of the rotor 40 within the concave 42, and larger elements, such as stalks, leaves and the like are discharged from the rear of the combine 10. Smaller elements of crop material including grain and non-grain crop material, including particles lighter than grain, such as chaff, dust and straw, are discharged through perforations of the concave 42.

Grain that has been separated by the threshing and separating assembly 24 falls onto a grain pan 44 and is conveyed toward the cleaning system 26. The cleaning system 26 may include an optional pre-cleaning sieve 46, an upper sieve 48 (also known as a chaffer sieve), a lower sieve 50 (also known as a cleaning sieve), and a cleaning fan 52. Grain on the sieves 46, 48 and 50 is subjected to a cleaning action by the fan 52, which provides an airflow through the sieves, to remove chaff and other impurities such as dust from the grain by making this material airborne for discharge from the straw hood 54 of the combine 10. The grain pan 44 and the pre-cleaning sieve 46 oscillate in a fore-to-aft manner to transport the grain and finer non-grain crop material to the upper surface of the upper sieve 48. The upper sieve 48 and the lower sieve 50 are vertically arranged relative to each other, and likewise oscillate in a fore-to-aft manner to spread the grain across sieves 48, 50, while permitting the passage of cleaned grain by gravity through the openings of sieves 48, 50.

Clean grain falls to a clean grain auger 56 positioned crosswise below and in front of the lower sieve 50. The clean grain auger 56 receives clean grain from each sieve 48, 50 and from bottom pan 58 of the cleaning system 26. The clean grain auger 56 conveys the clean grain laterally to a generally vertically arranged grain elevator 60 for transport to the grain tank 28. Tailings from the cleaning system 26 fall to a tailings auger trough 62. The tailings are transported via tailings auger 64 and the return auger 66 to the upstream end of the cleaning system 26 for repeated cleaning action. The cross augers 68 at the bottom of the grain tank 28 convey the clean grain within the grain tank 28 to the unloading auger 30 for discharge from the combine 10.

Although a rotary combine has been described thus far, it should be understood that the details presented herein are not limited to rotary combine and may be applicable to other machines, such as conventional combines and cross harvester combines.

A residue handling system 70 is integrated in the rear of harvester 10. Residue handling system 70 generally comprises a straw hood 54, a discharge beater 75, seed mills 77, a chopper 72, and horizontally oriented spreaders 74 that are all at least partially positioned within straw hood 54.

Referring now to the individual components of residue handling system 70, straw hood 54 includes opposing side walls 55 that are connected to a top wall 71. The walls 55 and 71 together define an interior space, which is referred to herein as a passageway 69 for straw and chaff.

A windrow mode selection door 76 is mounted to the top wall 71 of straw hood 54 at a location above the chopper 72. Door 76 pivots between two positions, namely, a deployed (i.e., extended) position and a retracted position shown in FIG. 3. In the deployed position, the first stream 80 of residue (straw), which is discharged from the discharge beater 75, is diverted over top of the chopper 72, through the windrow outlet of the machine 10 and onto a hood or chute (see FIG. 1) that guides the residue to form a windrow behind the machine 10. In the retracted position of door 76 shown in FIG. 3, the door 76 prevents the first stream 80 of residue from passing through the windrow outlet. And, the first stream 80 is directed to the residue chopper 72.

Discharge beater 75 is configured to deliver the stream 80 of straw material into the upper end of passageway 69 towards chopper 72. The cleaning system 26, which includes sieve 48, is configured to deliver a stream 78 of chaff material along the lower end of passageway 69. Stream 78 of chaff is designated by the double headed arrow shown in FIG. 3. Sieve 48 is mounted to a reciprocating cleaning shoe 49. Chopper 72 is configured to rotate and chop the straw material and deliver it to spreader 74. Chopper 72 is partially surrounded by a chopper housing 57 that comprises an interior facing wall 57a (or shroud) and an exterior facing wall 57b. The spreader 74 discharges the non-grain crop material across the harvested width behind harvester 10. Further details of discharge beater 75, chopper 72 and spreader 74 are provided in the '232 Patent.

It is noted that chopper 72 may be omitted, if so desired. For example, if beater 75 has two speed settings (e.g., high and low), there may not be a need to include a separate chopper 72 because the beater 75 can act as a chopper when it is operated at the high speed setting.

Turning now to FIGS. 3, 4, 6A and 6B, two seed mills 77 are positioned at the bottom side of straw hood 54. Each seed mill 77 receives a portion of second stream 78 of chaff from the cleaning system 26 via passageway 69. Seed mills 77 are powered by a belt 88 (or other device) that is positioned within the interior of straw hood 54. A cover 98 conceals the belt 88. It is noted that the cover 98 and belt 88 are shown partially cut-away in FIG. 3 to reveal further components of the combine. Further details in connection with seed mills 77 are described in U.S. Pat. No. 10,004,176, which is incorporated by reference in its entirety.

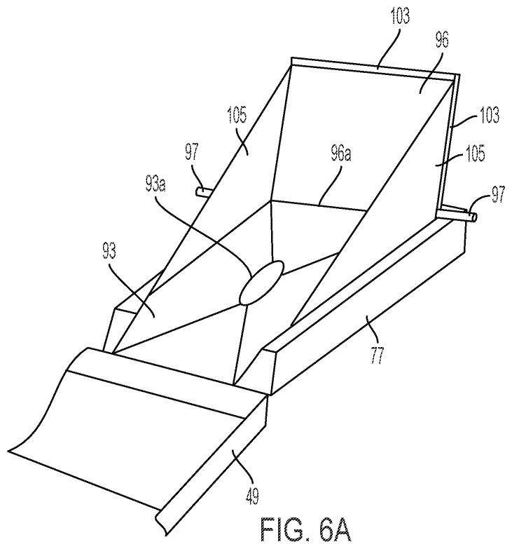

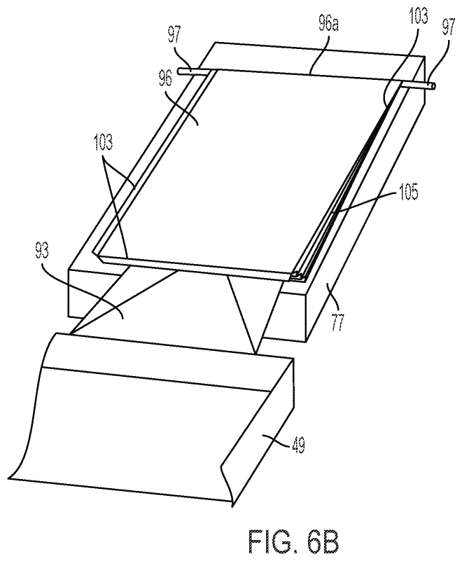

An oscillating pan 93 is mounted to reciprocating cleaning shoe 49 and oscillates therewith. Pan 93 includes a funnel-like surface and a central opening 93a formed at or near the center of the funnel-like surface. Central opening 93a is disposed above the inlet 77c of mill 77 for directing the chaff stream 78 into mill 77. It is noted that pan 93 is not necessarily limited to that which is shown and described. For example, opening 93a may be omitted and an tapered edge or surface of the pan 93 may overhang inlet 77c for directing the chaff stream into inlet 77c. A single pan 93 may be mounted to both mills 77, or, alternatively, one pan 93 may be mounted to one the mills 77 (as shown in FIGS. 6A and 6B) while a second pan 93 is positioned the other mill 77.

A seal 96, which may be composed of rubber or metal, for example, is pivotably mounted to the top surface of mill 77 (or another fixed point on the combine) at a location adjacent inlet 77c of mill 77. Alternatively, seal 96 may be mounted to the downstream edge of pan 93. The lower end of seal 96 is pivotably mounted at pivot point 96a (e.g., a hinge) and moves between a raised position and a lowered portion. In the raised position of seal 96, which is shown in FIGS. 3 and 6A, seal 96 prevents the passage of the chaff stream 78 towards spreader 74 via passageway 87. In the lowered position of seal 96 (FIG. 6B), seal 96 covers the central opening 93a of pan 93 to (i) prevent the passage of the chaff stream 78 into the mills 77, and (ii) permit the passage of the chaff stream 78 over top of seal 96 and into the passageway 87 towards spreader 74.

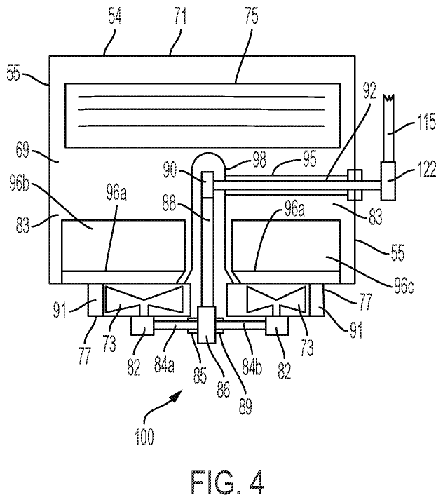

As best shown in FIG. 4, seal 96 is divided into two portions, namely, seal portion 96b and seal portion 96c (referred to collectively as seal(s) 96) that are positioned on opposing sides of cover 98. A rod 97 (FIG. 6A) extends along pivot points 96a and connects both seal portions 96b and 96c together. In use, rotation of rod 97 causes both seal portions 96b and 96c to move together. Rod 97 may be moved either manually or in an automated fashion by an electric motor, for example. Seal 96 may be latched in either the raised or lowered position by a fastener (bolt), spring pin, latch, or other means for latching.

Gaskets 103 may be positioned on the top, left and right sides of each seal portion 96b and 96c. In the raised position of the seals 96, the gaskets 103 prevent the chaff material from escaping through spaces between the seal portions 96b/96c and the cover 98. The gaskets 103 also prevent the chaff material from escaping through spaces between the seal portions 96b/96c and the sides 55 of the straw hood 54. Lastly, the gaskets 103 also prevent the chaff material from escaping through spaces between the seal portions 96b/96c and seal 59.

Foldable covers 105, which may be composed of canvas material, for example, are mounted to the left and right sides of each seal 96. One edge of cover 105 is mounted to the left or right edge of seal 96, and the other edge of cover 105 is mounted to the top surface of mill 77. In the raised position of seal 96 (shown in FIG. 6A), covers 105 and seal 96 together form a three walled structure that captures chaff stream 78 and delivers it onto pan 93 such that chaff stream 78 passes through opening 93a and into the mill 77 positioned beneath pan 93. In the lowered position of seal 96 (shown in FIG. 6B), covers 105 fold away beneath seal 96. Cover 105 could have a bellows-type structure, if so desired. Although a foldable cover 105 is shown mounted to only one of the seals 96 in FIGS. 6A and 6B, it should be understood that another cover 105 can be mounted to the other seal 96.

It is noted that covers 105 are omitted from FIG. 3, and would not be visible in FIG. 4. Also, although seals 96 and covers 105 are shown mounted to mill 77, it should be understood that seals 96 and covers 105 may alternatively be mounted to pan 93, such that seals 96 and covers 105 oscillate with pan 93.

Seal 59, which may be composed of rubber or metal, for example, is pivotably mounted to chopper housing wall 57a (or another fixed point on the combine). The connected end of seal 59 is pivotably mounted at pivot point 59a (e.g., a hinge) and moves between a raised position and a lowered portion.

In the raised position of seal 59, which is shown in FIG. 3, seal 59 registers with seal 96 to prevent the passage of the chaff stream 78 towards spreader 74 via passageway 87. In the lowered position of seal 59 (not shown), seal 59 is positioned against chopper housing wall 57a to permit the passage of the chaff stream 78 towards spreader 74 via passageway 87 (assuming that seal 96 is also maintained in the lowered position).

A rod passes through pivot point 59a of seal 59. And, that rod may be rotated either manually or in an automated fashion by an electric motor, for example. Seal 59 may be latched in either the raised or lowered position by a fastener (bolt), spring pin, latch, or other means for latching.

Seals 59 and 96 may also be referred to herein as doors or deflectors. Seal 59 is an optional component.

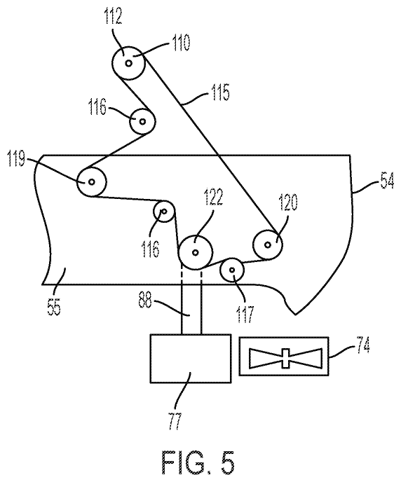

Turning now to FIG. 5, that figure shows a drive system that delivers power from the power take off (PTO) shaft of the combine to the chopper 72, mills 77 and other elements of the combine using a belt 115 on the exterior of the straw hood 54. Portions of the drive system are external of straw hood 54 whereas other portions of the drive system are internal to the straw hood 54. By way of background, conventional combines having weed seed mills and a chopper typically include three or more belts for powering those devices from a PTO shaft. The combine described herein only uses two belts (i.e., belts 115 and 88) for driving the chopper 72 and the mills 77, which is particularly advantageous from the perspective of efficiency, reliability, and cost. Belt 115 is external to straw hood 54, whereas belt 88 is internal to straw hood 54.

Referring still to the drive system shown in FIG. 5, a PTO shaft 110 on the combine is connected to receive power from the engine of the combine. A pulley 112 is positioned at the end of the shaft 110. The belt 115 is wound around the pulley 112. The belt is also wound about a pulley 119 that is connected to a shaft of beater 75. Idler pulleys 116 and 117 bear on belt 115 to impart tension to the belt 115 and remove any slack in the belt 115. The belt 115 is further wound about a chopper pulley 120 for rotating the pulley 120. A shaft extending from the pulley 120 is connected to the chopper 72 for rotating the chopper 72. The belt 115 is also wound around a jackshaft pulley 122 for rotating that pulley 122. A shaft 92 extends from pulley 122, and the shaft 92 is indirectly connected to the seed mills 77, as will be explained below. It is noted that the position of the above mentioned pulleys as well as the trajectory of belt 115 may vary from that which is shown and described. It is also noted that the belt 115 does not have to be would about pulley 119 and/or pulley 120 depending upon the configuration of the combine. It is further noted that the position of the idler pulleys 116 and 117 can vary, and the number of idler pulleys can vary.

FIGS. 3 and 4 depict the internal portion 100 of the drive system (i.e., at least partially internal to straw hood 54) that is configured for transferring power from the pulley 122 to the rotor of each seed mill 77. At the outset, it should be understood that the internal drive system 100 can be modified depending upon the location and style of seed mills 77. And, seed mills 77 are not limited to that which is shown and described herein.

Internal drive system 100 generally includes shafts 84a, 84b and 92, pulleys 86 and 90, gears 82 and belt 88. It is noted at the outset, however, that the internal drive system 100 is not limited to a belt drive including belt 88. For example, drive mechanism 100 may comprise a gearbox or a power take off shaft for transmitting power between shaft 92 and seed mills 77. And, if drive mechanism 100 includes such a gearbox or power take off shaft, then the portions of the gearbox or power take off shaft that are positioned within straw hood 54 would be concealed by cover 98.

Turning now to the individual components of internal drive system 100, one gear (referred to as an input member) of a bevel gear set 82 is connected to a rotor 73 of one of the seed mills 77. The other gear of the bevel gear set 82 is connected to one of the shafts 84a and 84b. Shafts 84a and 84b are releasably connected together by a releasable coupling 85. A pulley 86 is non-rotatably mounted to the shaft 84. A belt 88 is wound around the pulley 86 and a pulley 90. Belt 88 may be accessed (e.g., replaced, adjusted, etc.) by sliding coupling 85 along shaft 84a in a direction away from the belt 88. Alternatively, shaft 84a may be a collapsible shaft, as is known in the art, that can be disconnected from pulley 86. A bearing 89 supports pulley 86 and shaft 84b. Bearing 89 is especially useful for supporting shaft 84b when shaft 84a is disconnected from shaft 84b.

It is noted that bevel gear set 82 may be omitted if mills 77 are oriented vertically as opposed to the horizontal arrangement shown in FIG. 4.

Pulley 90 is non-rotatably connected to one end of a jackshaft 92 that extends through an opening formed in side wall 55 of the straw hood 54. Pulley 122 is non-rotatably connected to the opposite end of jackshaft 92 and is positioned outside of the straw hood 54. Belt 115 is wound around pulley 122, as was described above.

In operation, power from the engine (or other power source) is transferred to PTO shaft 110, which is transferred to pulley 122 via belt 115, which is transferred to pulley 90 via shaft 92, which is transferred to belt 88, which is transferred to pulley 86, which is transferred to both bevel gears 92 via shafts 84a and 84b, which is transferred to a rotor 73 positioned within each seed mill 77. Bevel gears 82 convert rotation along one axis to rotation along an orthogonal axis, as is known in the art. Power from PTO shaft 110 is also transferred to pulley 120 via belt 115, which is transferred to chopper 72. And, power from PTO shaft 110 is also transferred to pulley 119 via belt 115, which is transferred to beater 75. As noted above, pulley 120 or pulley 119 may be omitted depending upon the configuration of the combine.

Jackshaft 92, pulley 90 and at least a portion of belt 88 are positioned within passageway 69. Pulley 90 and belt 88 are enclosed by a cover 98 to either prevent or limit the amount of straw embedding on those elements. The leading and trailing ends 99 of cover 98 may be pointed edges to limit straw material from embedding on the surfaces of the cover 98. According to this example, cover 98 does not extend through upper wall 71. Rotatable shaft 92 is enclosed in a protective hollow tube 95 to prevent straw from contacting shaft 92. Cover 98, pulley 90, jackshaft 92 and tube 95 are positioned downstream of discharge beater 75 and upstream of chopper 72 in the direction of crop flow.

Cover 98 bifurcates chaff passageway 83 into two separate and narrowed passageways, as shown in FIG. 4. Each passageway 83 leads to an inlet of one of the seed mills 77. A rotor 73 is positioned within the hollow interior of each mill 77, and is surrounded by a concave or stator, as is known in the art and described in the '232 Patent. Destroyed seeds are outputted from seed mill 77 via an outlet port 91.

By positioning the drive mechanism 100 at least partially in passageway 69, it is not necessary to position any mechanisms for powering the seed mills 77 within the rear wheel wells of the combine 10 at a location that would interfere with the turning radius of the rear wheels. It is noted that pulley 122 is positioned well above the rear wheels.

Although not shown, cover 98, pulley 90, and belt 88 do not have to be positioned in the center of the straw hood 54, as viewed in FIG. 4. Those components may be positioned to one side of the straw hood 54, such as against the sidewall 55. If such a modification were made, the rotors 73 could be connected in series (as opposed to the parallel connection shown in FIG. 4).

It is noted that mills 77 may be operated at about 3000 rpm for destroying weed seeds, whereas spreaders 74 may be operated at about 800 rpm for expelling straw and/or chaff onto the ground. Stated differently, spreaders 74 are operated at a lower rotational speed than mills 77. It should be understood that the particular details of the seed mills 77, spreader 74 and chopper 72 may vary from that which is shown and described.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural harvester comprising:
an oscillating cleaning shoe to which one or more sieves are connected,
a seed mill having an inlet for receiving a stream of chaff material, and an outlet through the stream of chaff material is expelled, and
a pan that is configured to be connected to the oscillating cleaning shoe, said pan having a surface that is configured to direct the stream of chaff material into the inlet of the seed mill.

2. The agricultural harvester of claim 1 further comprising a spreader positioned downstream of the seed mill as viewed in a direction of the stream of chaff material, wherein the spreader is configured to be rotated at a speed that is less than a rotational speed of the seed mill.

3. The agricultural harvester of claim 1, further comprising a sieve mounted to the cleaning shoe.

4. The agricultural harvester of claim 1, further comprising a seal mounted at an elevation above the pan, wherein the seal is movable between (i) a raised position for directing the stream of chaff material onto the pan, and (ii) a lowered position for directing the stream of chaff material over the pan.

5. The agricultural harvester of claim 4, wherein the seal is pivotably mounted to either the seed mill or the pan.

6. The agricultural harvester of claim 4, wherein the pan includes an opening on said surface that is positioned above the inlet of the seed mill, and, in the lowered position of the seal, the seal covers the opening.

7. The agricultural harvester of claim 4 further comprising foldable covers mounted to opposing sides of the seal, wherein, in the raised position of the seal, the seal and the foldable covers together form a three-walled structure for directing the stream of chaff material onto the surface of the pan, and in the lowered position of the seal, the foldable covers are folded either beneath or beside the seal.

8. The agricultural harvester of claim 4, further comprising a straw chopper, a shroud at least partially surrounding the straw chopper, and a second seal that is movably mounted to the shroud, wherein the second seal is moveable between a deployed position where the second seal is positioned either adjacent or in contact with the seal, and a retracted position where the second seal is not positioned adjacent the seal.

9. The agricultural harvester of claim 4, further comprising a straw spreader positioned downstream of the seed mill, wherein in the raised position of the seal, the seal blocks the stream of chaff material from reaching the straw spreader, and, in the lowered position of the seal, the seal does not block the stream of chaff material from reaching the straw spreader.

10. The agricultural harvester of claim 4, further comprising a gasket mounted about at least a portion of the seal.

11. The agricultural harvester of claim 4, further comprising a straw hood, a second seed mill, and a drive mechanism positioned within an interior region of the straw hood for powering the seed mills, wherein the seal is divided into a first seal portion that is positioned on one side of the drive mechanism and a second seal portion that is positioned on an opposite side of the drive mechanism.

12. The agricultural harvester of claim 1, wherein the seed mill comprises a rotor and stator, and the rotor is configured to rotate with respect to the stator for damaging weed seeds passing between the rotor and stator.
